(19) United States
(12) Patent Application Publication
(10) Pub. No.: US 2023/0145462 A1
(43) Pub. Date: May 11, 2023

(54) LOCATION-BASED TRIVIA GAME PLATFORM

(71) Applicant: Joshua D. England, Portland, TN (US)

(72) Inventor: Joshua D. England, Portland, TN (US)

(21) Appl. No.: 17/522,103

(22) Filed: Nov. 9, 2021

(51) Int. Cl. A63F 13/216; A63F 13/792; A63F 13/80; A63F 13/533

(52) U.S. Cl. CPC A63F 13/216; A63F 13/792; A63F 13/80; A63F 13/533; A63F 2300/308; A63F 2300/5573; A63F 2300/5513; A63F 2300/8064

(57) ABSTRACT

A location-based trivia system is described herein that leads a player through a treasure hunt game to a variety of real-world locations, where the location is the answer to one or more trivia questions. The system determines the player's initial location to determine where the game will start for that player. The game then asks the player a trivia question, where the answer is a location. When the player successfully answers the question by arriving at the correct location, the game advances to the next goal, which may be either another trivia question or the conclusion of the game. Thus, the location-based trivia system guides players through an exciting trip around their city or other location, and the players compete based on their ability to correctly answer the questions.

### BACKGROUND

A scavenger hunt is a game in which the organizers prepare a list defining specific items, and the participants seek to gather or complete all items on the list. Usually participants work in small teams, although the rules may allow individuals to participate. The goal is to be the first to complete the list or to complete the most items on the list. In variations of the game, players take photographs of listed items or are challenged to complete the tasks on the list in the most creative manner. A treasure hunt is another name for the game, but it may involve following a series of clues to find objects or a single prize in a particular order.

Pokémon Go is a 2016 augmented reality (AR) mobile game developed and published by Niantic in collaboration with Nintendo and The Pokémon Company for iOS and Android devices. The game uses mobile devices with global positioning system (GPS) hardware to locate, capture, train, and battle virtual creatures, called Pokémon, which appear as if they are in the player's real-world location. It was one of the most used and profitable mobile apps in 2016, having been downloaded more than 500 million times worldwide by the end of the year. It is credited with popularizing location-based and AR technology, promoting physical activity, and helping local businesses grow due to increased foot traffic. The game had over 147 million monthly active users by May 2018, over a billion global downloads by early 2019, and grossed more than $6 billion in revenue as of 2020.

Mobile devices with GPS hardware have become ubiquitous, available in all parts of the world and at a variety of price points that are affordable to many. It is now possible for games and other applications to leverage a user's real-world location as input to make a variety of decisions. This allows for a blending of real and generated content that was not previously possible. AR is an interactive experience of a real-world environment where the objects that reside in the real world are enhanced by computer-generated perceptual information, sometimes across multiple sensory modalities, including visual, auditory, haptic, somatosensory and olfactory. AR can be defined as a system that incorporates three basic features: a combination of real and virtual worlds, real-time interaction, and accurate 3D registration of virtual and real objects. The primary value of augmented reality is the way components of the digital world blend into a person's perception of the real world, not as a simple display of data, but through the integration of immersive sensations, which are perceived as natural parts of an environment.

Most existing AR games rely on bringing fictional characters into the real world and do not provide any education or historical value to the locations that the user is visiting. Part of the interest of the real-world locations is their history and actual meaning, but existing games fail to capitalize on this aspect of the locations. Not only can players learn more about the locations that they are visiting, but they may discover locations that they would like to return to after playing the game to enjoy the history of those locations.

### BRIEF DESCRIPTION OF THE DRAWINGS

FIG. 1 is a block diagram that illustrates components of the location-based trivia system, in one embodiment.

FIG. 2 is a flow diagram that illustrates processing of the location-based trivia system to define a game, in one embodiment.

FIG. 3 is a flow diagram that illustrates processing of the location-based trivia system to play a game, in one embodiment.

### DETAILED DESCRIPTION

A location-based trivia system is described herein that leads a player through a treasure hunt game to a variety of real-world locations, where the location is the answer to one or more trivia questions. The system determines the player's initial location to determine where the game will start for that player. The game then asks the player a trivia question, where the answer is a location. The player answers the question by going to the location, which is detected by using the GPS hardware of the player's mobile device on which the game runs. When the player successfully answers the question by arriving at the correct location, the game advances to the next goal, which may be either another trivia question or the conclusion of the game. Players may pay to play the game and may win one or more prizes based on their performance in the game. In some cases, multiple players play the game, and the game selects an ending location to bring all the players to the same final location. Thus, the location-based trivia system guides players through an exciting trip around their city or other location, and the players compete based on their ability to correctly answer the questions.

The location-based trivia system supplies a platform for building games that use local landmarks to advance a story line to a conclusion. The system issues a trivia question, and the system recognizes a correct answer by the GPS coordinates of the player. For example, the platform may ask a trivia question where the answer is Bridgestone Arena in Nashville, Tenn. The player will pick Bridgestone Arena from a dropdown list of all locations in the game. When answered correctly the game will confirm the player's answer is correct and give them directions to Bridgestone Arena. Once the player reaches the end destination given by the directions, the game will unlock the next trivia question. The system can issue questions in many forms, such as via written or spoken word, pictures, video, or other forms that a game designer chooses.

The location-based trivia system manages a database of local GPS locations, created by a game designer to define a particular trivia game. Each location includes an associated riddle or a clue where the correct answer is the location the clue is tied to. Game designers can create themed games utilizing the database (e.g., Bomb in the City; Treasure Hunt; Catch a Killer, etc.).

The game is broken down into two phases: a story phase and a final game phase. Most of the game's clues/locations are part of the story phase. The clues/locations can be given in any order. Once all the clues/locations are collected the complete storyline for the game is revealed. In the final game phase, the clues/locations are in a specific order to complete the story/game. The system allows a player to start the game from anywhere in the city or other playing region. The game uses the GPS coordinates from the player's current position and calculates a route (e.g., the shortest) for that user to complete the game. The system may also ensure that no two players in the same game receive the same route. This minimizes “piggy-backing” as much as possible. The first player to solve all the riddles and check in at the last GPS coordinate wins.

In some embodiments, each game has a visible scoreboard for all the players competing. At any time, each player can look at the scoreboard and see each of his competitors and how many clues they have completed. Once the first player completes the game, the game may stop, and all players are notified who won. In some variants, the remaining players do not complete the game, and the only player to see the conclusion of the game is the player who wins. In other variations, the system tracks an order of completion of players so that prizes can be given to first, second, third, and so forth. An overall leaderboard will show times for all winners in order from fastest to slowest. This leaderboard will allow players to send each other messages and invitations to games. This creates a community around the game.

The system can be monetized in a variety of ways. In one model, the game is a free download/pay-per-play model. Players will pay for each game they play in. In another model, advertising is shown to players as they play, and the ads pay for the game. In some variations, sponsors may pay for an instance of the game that is specially branded to promote an event, city, or organization.

In some embodiments, the game designer chooses a finishing location for all players to meet at the end of the game. This location may be the final clue, or it may be a meeting location that is not part of the timed game. By meeting together, the players can form a community and the game designer may provide a branded experience to the game. Bike/scooter rental companies can use the location-based trivia system to provide a unique treasure hunt with their rented scooters, so that riders get to tour the city by playing the game. The final destination can be a location to which the rental company wants the scooter returned or other destination.

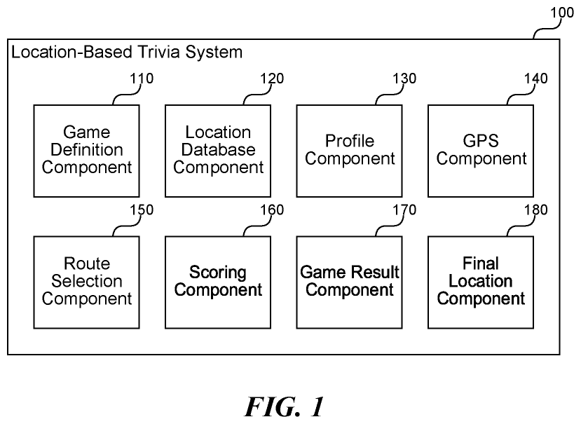

FIG. 1 is a block diagram that illustrates components of the location-based trivia system, in one embodiment. The system 100 includes a game definition component 110, a location database component 120, a profile component 130, a GPS component 140, a route selection component 150, a scoring component 160, a game result component 170, and a final location component 180. Each of these components is described in further detail herein.

The game definition component 110 receives from a game designer a list of locations and questions that make up an instance of a trivia game to be hosted by the system 100. The list of locations may include one or more questions and one or more locations that are answers to the questions that a player playing the game will visit to progress in the game. The list of locations may also identify special locations, such as a finishing location common to all players, or one or more locations that may be preferred starting locations. The game definition component 110 may also receive branding information that identifies a host or purpose of the game. The game definition component 110 populates the location database 120 with locations associated with the game.

The location database component 120 stores the received list of locations for one or more trivia games. The location database component 120 can be any type of data store including a cloud-based data storage facility (e.g., Amazon AWS), an online database (e.g., Oracle, MySql), one or more storage devices (e.g., hard drives, solid-state disks), or any other manner of storing the set of locations and questions that comprise an instance of a location-based trivia game. The location database component 120 may include a security model so that a game designer can modify locations and questions associated with his/her game, but others can only read/access the locations to play the game. The profile component 130 identifies each person with access to the system 100 and manages their particular type of access.

The profile component 130 stores information describing each user of the system 100 including players and game designers and authentication information for each user. The authentication information may include a username and password, two-factor authentication information, biometric authentication information (e.g., fingerprint or facial identifier), and so forth. The profile component 130 may also store historical usage information for each user of the system 100, such as past games played, score achieved, money spent/won, achievements, time spent playing, and so on. The profile component 130 may provide a user interface for a user of the system 100 to view his/her profile as well as for others to search the profile of the user.

The GPS component 140 provides a player's location from GPS hardware of the player's mobile device upon request by the system 100. The GPS component 140 may be used to determine whether the player has gone to the correct location to answer a trivia question in order to receive the next clue/question. The GPS component 140 may also be used to determine from where the player is starting the game to determine an appropriate starting and ending location for the player. The GPS component 140 may also report to a central location that allows a map to be displayed of all players currently playing the game, so that a game designer or game host can know who is playing the game and how well they are currently doing.

The route selection component 150 orders the received list of locations and questions that make up a location-based trivia game for each player so that each player starts at a location in the received list that is close to the player's actual starting location. The route selection component 150 may also ensure that two players are not going to similar locations at the same time so that the players do not give themselves an advantage by following another player. The route selection component 150 may also consider other factors, such as the difficulty of a particular route, shortest path analysis, traffic, weather, road closures, or any other factors that may suggest one route is better or worse than another. The game designer may leverage the system 100 to enforce a type of routing that best suits each particular game. For example, for some events it may be desirable to have players arrive at a location when a particular event is occurring, and the component 150 can select routes for each player that make this timing more likely.

The scoring component 160 tracks time of play for each player and assigns a score to each player based on progress through the received list of locations. As a player correctly answers questions and progresses through the locations, the player's score will increase. A player that does this faster will have a higher score than a player that does this slower. A game designer may also incorporate other scoring aspects that the scoring component 160 will honor and enforce, such as bonus activities that earn extra points at some locations.

The game result component 170 determines a player that wins the game based on which player completes the received list of locations first and that player's assigned score. The game designer may require particular activities to be completed to win, while other activities may be optional. In some cases, multiple players may finish the game, but a later finishing player could achieve a higher score by completing bonus activities. It is up to each game designer to define criteria that constitute winning for their game.

The final location component 180 may guide players to a final location for a meet up after the game is concluded. The final location may be a scored location or a non-scored location. In some cases, due to the route selected by the route selection component, each player may end at a different location and the game may want to cause the players to meet by leading them to a common final location. The final location could be a landmark related to the game, a business owned by the host of the game, or other significant location. The final location may be optional, meaning some players may choose to go home after completing the game and not go to the final location. For those that go to the final location, the game host may offer prizes, celebrations, merchandise, or other incentives and rewards for playing the game.

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Program modules include routines, programs, objects, components, data structures, and so on that perform tasks or implement particular abstract data types. Typically, the functionality of the program modules may be combined or distributed as desired in various embodiments.

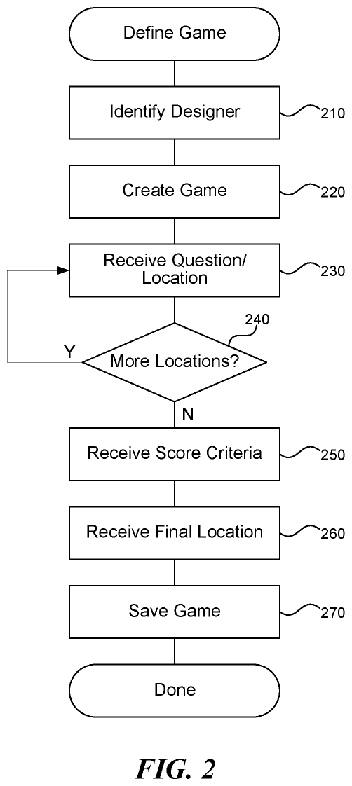

FIG. 2 is a flow diagram that illustrates processing of the location-based trivia system to define a game, in one embodiment. Beginning in block 210, the system receives an identification of a game designer that is using the system to create a new game defined by a plurality of questions and locations that are answers to the questions. The system receives user information from the game designer that identifies the game designer and looks up a stored profile for the game designer. If no profile yet exists, the system may allow the game designer to create a new profile. The profile may determine which games the game designer can access and modify and whether the game designer can create new games.

Continuing in block 220, the system receives an indication that the game designer wants to create a new game. The system may receive summary information about the game, such as a title, name for the game, branding information (e.g., logos, banners, and so forth), host of the game, time the game is to be played, and so on. The game designer may pay to use the system and/or players may pay to use the system. In some embodiments, the designer and system operator split player payments for playing the game so that each makes a profit.

Continuing in block 230, the system receives a question from the game designer and a location that is an answer to that question. In the case of a multiple-choice type of question, the system may also receive one or more locations that are incorrect answers to the question and information about how many tries a player gets to answer the question correctly. In some cases, the player may be penalized for incorrect answers, such as having to wait five minutes to try again. This can cause other players to get ahead of the penalized player. Questions can take any form, such as, “Where did Andrew Jackson live?” A correct answer in Nashville would take the form, “The Hermitage,” and players answering correctly would then be directed to The Hermitage to get the next question. The game can be played where players go to the location to provide the answer, meaning players might also lose time by going to the wrong location, or where players must answer correctly first and the game then directs them to that location. Gameplay decisions can be left by the system to the game designer.

Continuing in decision block 240, if the game designer has more locations for the game, then the system loops to block 230 to receive the next question/location pair, else the system continues at block 250. A game can have any number of questions/locations, and a game may be defined by the players answering all the questions correctly or by answering a threshold number of questions correctly. For example, a game designer could design a game with 100 questions but answering 25 of the questions could be sufficient to complete the game. In such embodiments, the players may be led through a different set of locations based on where each players starts. This gives the game more route flexibility and more ability to keep the players apart to avoid piggybacking of players.

Continuing in block 250, the system receives one or more scoring criteria from the game designer. Scoring criteria decide how the players of the game earn points and finish the game. Scoring criteria may include a number of points for a correct answer, a point deduction for incorrect answers, a point bonus for answering questions quickly, a point bonus for completing one or more bonus activities at a location, and so forth.

Continuing in block 260, the system receives an optional final location from the game designer that defines a location to have players meet at the end of the game. The final location may or may not be a scored location. The final location could have significance to the topic of the game (e.g., historical landmarks) or may be related to the game designer or game host, such as a place of business of the host (e.g., a bar where players meet after). At the final location players may receive awards, prizes, and so on.

Continuing in block 270, the system saves the game defined by the game designer to a data storage device. The data storage device may be any type of storage system, such as a cloud-hosted database service, where players can access the game data. Game players may run a custom application on their mobile device (e.g., an app downloaded from the Apple App Store or Google Play Store) that accesses the data storage device to retrieve the game definition. Game designers may use the same or a separate authoring application for defining new games. After block 270, these steps conclude.

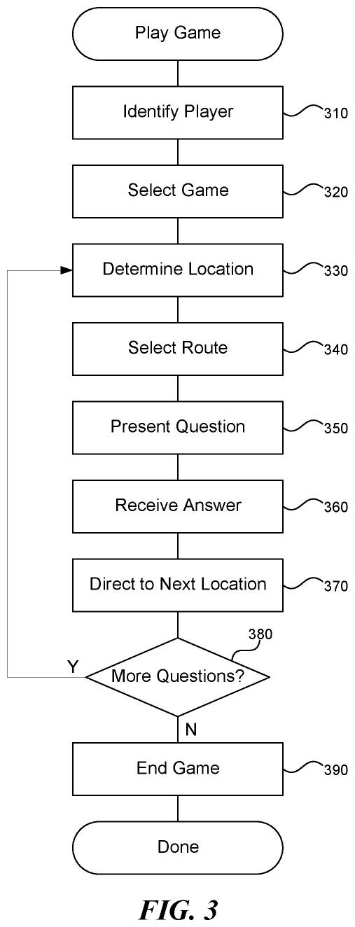

FIG. 3 is a flow diagram that illustrates processing of the location-based trivia system to play a game, in one embodiment. Beginning in block 310, the system receives an identification of a player that is using the system to play a game defined by a plurality of questions and locations that are answers to the questions. The system receives user information from the player that identifies the player and looks up a stored profile for the player. If no profile yet exists, the system may allow the player to create a new profile. The profile may decide which games the player can play. The profile may also track money paid in by the player that can be applied to play new games.

Continuing in block 320, the system receives a selection of the game from the player. The system may supply a list of games to the player, or the player may be sent a link that takes the player to a specific game. The system is capable of hosting thousands of games at a time across many different cities and countries. The system may filter the available games to those that are currently available a reasonable distance from the player's current location. For example, if the player is in Nashville, then the system may offer the player games taking place in the Nashville Metro area. The player chooses a game from a user interface and the system receives the player's selection.

Continuing in block 330, the system decides the player's current location from GPS hardware of the player's mobile device on which the system runs. The system may invoke one or more application programming interfaces (APIs) provided by the operating system of the player's mobile device to obtain the player's current location. The operating system may ask the player's permission to supply the player's location to the system. The operating system may supply the location as a set of latitude and longitude coordinates or in any other form that the system can use to operate the game.

Continuing in block 340, the system selects a route based on the player's current location and one or more remaining locations to be visited in the game. If the player has just started the game, then the route may take the player first to the closest location, and then through a series of locations that defines the shortest path between all the locations from the player's starting point. In some games, the game designer may ask that points be visited in a particular order, and that order may inform the route selected by the system. Each player may start at a different location and may follow a different route, depending on the algorithm used by the route selection.

Continuing in block 350, the system presents a next trivia question to the player, where the answer to the question identifies a next location that the player will visit. The player supplies the answer to the question via a user interface of the system. The system may present the question in a user interface of a mobile application running on the player's mobile device. The system may also provide one or more multiple-choice answers along with the question, so that the player can select an answer from several choices. The system may also read the question to the player audibly through the mobile device's speakers.

Continuing in block 360, the system receives an answer to the next trivia question from the player and decides whether the answer is correct. If the answer is correct, then the system directs the player to the next location in the selected route. If the answer is incorrect, the system may provide the player with another chance to answer correctly, although the player may be penalized in some way, such as through a forced time delay or deducted points. The system may receive the answer through a user interface, such as a displayed set of options on a touch screen or the player may speak the answer such as via a virtual personal assistant (e.g., Apple's Sin or Google's Hey Google).

Continuing in block 370, the system directs the player to go to the next location identified by the player's answer and determines through the GPS hardware of the player's mobile device when the player has arrived there. When the player arrives at the next location, the system proceeds to the next question in the selected route. If the player does not go to the directed location within a specified period, then the player may lose or forfeit the game. In some embodiments, the player may have an option to select among multiple next locations. In other embodiments, the system may reorder next locations to keep multiple players from arriving at the same location at the same time. The system may elect to spread players out to avoid piggybacking or other forms of cheating or undue advantage. The system may also take external factors into account, such as traffic.

Continuing in decision block 380, if there are more questions in the selected route, then the system loops to block 330 to determine the player's new location, else the system continues to block 390 to conclude the game. The system may run each player through all the questions associated with the game or may select a set number of questions at which to cap the game, as specified by the game designer. In some embodiments, the system gives each player the same final question to direct all the players to end at a desired final destination.

Continuing in block 390, the system ends the game and declares one player to be the winner based on finishing the most questions faster than other players. The game designer can define whether there will be second, third, and additional place players, and what rewards players earn for placing. Some games may have no winner and other games may have multiple winners, as defined by the game designer. Some games may be limited to a short duration (e.g., an hour) while others may span a longer duration (e.g., days). After block 390, these steps conclude.

From the foregoing, it will be appreciated that specific embodiments of the location-based trivia system have been described herein for purposes of illustration, but that various modifications may be made without deviating from the spirit and scope of the invention. Accordingly, the invention is not limited except as by the appended claims.

I/we claim:

1. A computer-implemented method to play a location-based trivia game, the method comprising:
receiving an identification of a player that is using the system to play a game defined by a plurality of questions and locations that are answers to the questions;
receiving a selection of the game from the player;
determining a current location of the player from GPS hardware of a mobile device of the player;
selecting a route based on the player's current location and one or more remaining locations to be visited in the game;
presenting a trivia question to the player, where the answer to the question identifies a next location that the player will visit;
receiving an answer to the trivia question from the player and determining whether the answer is correct;
upon determining that the answer is correct, directing the player to go to the next location identified by the player's answer and determining through the GPS hardware of the player's mobile device when the player has arrived there; and
after the player has visited each of the one or more remaining locations, concluding the game and declaring one player to be the winner based on finishing the most questions faster than other players,
wherein the preceding steps are performed by at least one processor.

2. The method of claim 1 wherein receiving the identification of the player comprises receiving user information from the player that identifies the player and looking up a stored profile for the player.

3. The method of claim 2 wherein the profile determines which games the player can play.

4. The method of claim 2 wherein the profile tracks money paid in by the player that can be applied to play new games.

5. The method of claim 1 wherein receiving the selection of the game comprises providing a list of currently in-progress games to the player wherein the list is filtered to include only games that are currently available a reasonable distance from the player's current location.

6. The method of claim 1 wherein receiving the selection of the game comprises displaying a user interface from which the player can select a game and receiving the player's selection from the displayed user interface.

7. The method of claim 1 wherein selecting a route comprises selecting a closest location of the one or more remaining locations to be visited.

8. The method of claim 1 wherein presenting the trivia question comprises presenting the question in a user interface of a mobile application running on the player's mobile device.

9. The method of claim 1 wherein presenting the trivia question comprises providing a plurality of multiple-choice answers along with the question, so that the player can select an answer from several choices, each answer comprising a different location.

10. The method of claim 1 wherein determining whether the answer is correct comprises upon determining that the answer is incorrect, providing the player with another chance to answer correctly and assigning a penalty to the player for the incorrect answer.

11. The method of claim 1 further comprising reordering next locations to keep multiple players from arriving at a same location at a same time to spread players out and avoid piggybacking between players.

12. The method of claim 1 further comprising at the end of the game, directing each player to a final location where the players can meet up.

13. A computer system for hosting a location-based trivia game, the system comprising:
a processor and memory configured to execute software instructions embodied within the following components;
a game definition component that receives from a game designer a list of locations and questions that make up an instance of a trivia game to be hosted by the system;
a location database component that stores the received list of locations for one or more trivia games and provides the list of locations to players of the game through a user interface of the game;
a profile component that stores information describing each user of the system, including players and game designers, and authentication information for each user;
a global positioning system (GPS) component that provides a player's location from GPS hardware of a mobile device of the player;
a route selection component that orders the received list of locations and questions that make up a location-based trivia game for each player so that each player starts at a location in the received list that is close to the player's actual starting location;
a scoring component that tracks time of play for each player and assigns a score to each player based on progress through the received list of locations; and
a game result component that determines a winning player that wins the game based on which player completes the received list of locations first and the winning player's assigned score.

14. The system of claim 13 wherein the list of locations comprises one or more questions and one or more possible locations that are answers to the questions that a player playing the game will visit to progress in the game.

15. The system of claim 13 wherein the profile component stores historical usage information for each user of the system including at least one of: past games played, score achieved, money spent and won, achievements, and time spent playing.

16. The system of claim 13 wherein the system accesses the GPS component to determine whether a player has gone to the correct location to answer a trivia question in order to receive the next clue/question.

17. The system of claim 13 wherein the system accesses the GPS component to determine from where the player is starting the game to determine a player-specific starting and ending location for the player.

18. The system of claim 13 wherein the route selection component ensures that two players are not going to similar locations at the same time so that the players do not give themselves an advantage by following another player.

19. The system of claim 13 further comprising a final location component that guides players to a final location for a meet up after the game is concluded.

20. A computer-readable storage medium comprising instructions for controlling a computer system to define a location-based trivia game, wherein the instructions, upon execution, cause a processor to perform actions comprising:
receiving an identification of a game designer that is using the system to create a new game defined by a plurality of questions and locations that are answers to the questions;
receiving an indication that the game designer wants to create a new game through a user interface of the system;
receiving one or more questions from the game designer and one or more locations that are answers to the questions;
receiving one or more scoring criteria from the game designer., wherein the scoring criteria determine how the players of the game earn points and finish the game;
receiving an optional final location from the game designer that defines a location to have players meet at the end of the game; and
saving the game defined by the game designer to a data storage device.
